(19) United States
(12) Patent Application Publication
(10) Pub. No.: US 2018/0363311 A1
(43) Pub. Date: Dec. 20, 2018

(54) MODULAR SLEEPING STRUCTURE, SLEEPING MODULE AND THEIR USE IN A VEHICLE OR BUILDING

(71) Applicant: Space Is Limited, Sheung Wan (HK)

(72) Inventors: Chun Zhu Joe LIAO, Sheung Wan (HK); Li Xin KOT, Sheung Wan (HK)

(21) Appl. No.: 15/780,870

(22) PCT Filed: Aug. 2, 2017
(86) PCT No.: PCT/CN2017/095574

§ 371 Date: Jun. 1, 2018

(30) Foreign Application Priority Data
Aug. 2, 2016 (HK) 16109204.5

(51) Int. Cl. E04H 1/02; E04H 1/12

(52) U.S. Cl. CPC E04H 1/02; G06Q 50/12; E04H 1/12

(57) ABSTRACT

A sleeping module and a modular sleeping structure with a plurality of sleeping modules. The sleeping modules has a housing which defines a space dimensioned to accommodate a user in at least a lie-flat position, an entrance to permit access to and exit from the space of the housing, an openable closure member provided with the housing to at least partially obstruct the entrance for isolating the space from the surroundings and a holder useful with the openable closure member is provided at the housing to releasably hold the openable closure member in a closed position by way of an attractive force.

### TECHNICAL FIELD

The present invention provides a sleeping module, a modular sleeping structure comprising a plurality of sleeping modules and a method of accessing the sleeping module.

### BACKGROUND OF THE INVENTION

There is a steady growth in the need for accommodation in sites that are characterized by a limited or finite amount of space, including dense metropolitan cities, such as Hong Kong, Tokyo and Beijing, or places where short-term accommodation is of high demand, such as airports and train stations. Inexpensive and temporary sleeping or rest accommodations are often required in case of sporting or other events in which mass convention is required. In such sites where space is limited or finite, there exists a tradeoff between the occupancy and comfort: In air traffic, there is a continuous demand in increasing the carriage capacity of the aircraft without compromising the quality of service and passenger's comfort. This is also true for trains, buses, boats or ships, and is of particular concern with long haul transportation.

In the above-mentioned examples, a passenger's access to comfort and privacy is limited by high occupancy rates and correspondingly low allotments of area. Thus, in many cases higher occupancy has contributed to an overall lower degree of comfort.

Thus, there remains an increasing and strong need for arrangements allowing passengers to sleep or rest in a comfortable and safe manner while ensuring a sufficient privacy and without the need for a lot of installation space.

Moreover, arrangements are required which can be easily adapted according to the individual accommodation needs.

The above-mentioned conditions call for a solution that can balance the dueling demands for high occupancy and adequate comfort. The invention seeks to eliminate or at least to mitigate the shortcomings or problems with known arrangements by providing a new or otherwise improved sleeping module. It provides accommodations that are sufficiently flexible, accessible, and ergonomic in a minimal volume of space.

### SUMMARY OF THE INVENTION

According to the first aspect of the invention there is provided a sleeping module comprising a housing defining a space dimensioned to accommodate a user in at least a lie-flat position, an entrance to permit access to and exit from the space of the housing, an openable closure member provided with the housing to at least partially obstruct the entrance for isolating the space from the surroundings, characterized in that a holder useful with the openable closure member is provided at the housing to releasably hold the openable closure member in a closed position by way of an attractive force.

Preferably, the openable closure member is held in the closed position by way of magnetic force.

More preferably, the entrance comprises an opening on a wall of the housing delimited by an edge portion.

Yet more preferably, the edge portion is equipped with a magnet.

Advantageously, the open able closure member is equipped with a magnet for magnetically engaging the edge portion of the entrance.

More advantageously, the openable closure member comprises a foldable closure member.

Yet more advantageously, the openable closure member is air permeable.

It is preferable that the wall of the housing includes a hollow portion for passage of electricity and water supply to the space.

More preferably, the wall of the housing comprises a double wall with the hollow portion formed therebetween.

Yet more preferably, the hollow portion is located at a top portion of the housing.

Advantageously, the housing defines an auxiliary space externally of the housing and in a corner at intersection of two orthogonal imaginary border planes of the housing.

More advantageously, the wall of the housing includes two wall portions extending along first and second imaginary planes, the first and second imaginary planes intersect forming an imaginary intersection point, the two wall portions are connected by a further wall portion that extends behind the intersection of the first and second imaginary planes creating an auxiliary space external of the housing.

In a second aspect of the invention there is provided a modular sleeping structure comprising an assembly of at least two of the sleeping modules as claimed in any one of claims 1 to 12, wherein the sleeping modules are arranged side-by-side to define a common channel for collective supply to pass which then branch off to supply the respective sleeping module.

Preferably, the collective supply includes at least one of a mechanical, electrical and plumbing system.

Advantageously, the common channel includes the auxiliary space of at least one sleeping module.

More advantageously, the common channel is at least partially defined by the further wall portion of at least one sleeping module.

More preferably, the sleeping modules are accessible to and from by the provision of a transportation structure supported by at least one of the sleeping modules.

Yet more preferably, the transportation structure comprises a ladder being mounted to the sleeping module by a support frame.

It is preferable that the ladder includes a plurality of steps connected by a shaft which has an upper portion forming a handle.

Preferably, the sleeping modules are affixed to each other.

More preferably, the sleeping modules are affixed to each other by way of mechanical coupling.

Yet more advantageously, sleeping modules are affixed to resist lateral movement by way of mutual support.

It is advantageous that the housing comprises an exterior covered by a layer of material for structural or visual enhancement.

Preferably, the modular sleeping structure includes a control module for controlling device installed in the sleeping module, the control module is guarded by a security system.

In a third aspect of the invention there is provided a method of accessing the sleeping module as claimed in anyone of claims 1 to 22 by the user including the steps of:

providing identification information of the user to the control system;
providing information of an intended period of use to the security system; receiving a key generated by the control system, the key permits access to the sleeping module and control of the device; and
presenting the key to the control system thereby gaining access to the sleeping module.

Preferably, the key stores information provided by the user, by presenting the key to the control system, stored information become accessible by the control system.

Preferably the method includes the step of indicating preference settings on device provided with the sleeping module.

More preferably, the preference settings are stored with the key or the control system.

Yet more preferably, the key comprises a QR code.

### BRIEF DESCRIPTION OF THE DRAWINGS

The invention will now be more particularly described, by way of example only, with reference to the accompanying drawings, in which:

FIGS. 1A and 2A are front perspective views of an embodiment of a sleeping module of the invention;

FIGS. 2A and 2B are rear perspective views of the sleeping module in FIGS. 1A and 1B;

FIGS. 3A and 3B are the front and rear views of the sleeping module in FIGS. 1A and 1B;

FIGS. 4A and 4B are the top and bottom plan views of the sleeping module in FIGS. 1A and 1B;

FIG. 4C is a cross-sectional view of the sleeping module in FIGS. 1A and 1B taken along line A-A of FIG. 3A;

FIG. 5A is a left side view of the sleeping module in FIGS. 1A and 1B;

FIG. 5B is a cross-sectional view of the sleeping module in FIGS. 1A and 1B taken along line B-B of FIG. 3A;

FIG. 5C is a right side view of the sleeping module in FIGS. 1A and 1B;

FIG. 6 is an exploded view of the sleeping module in FIGS. 1A and 1B;

FIG. 7A is a front view of a closure member of the sleeping module in FIGS. 1A and 1B;

FIG. 7B is a front view of a frame on the sleeping module in FIGS. 1A and 1B defining an entrance and for co-operating with the closure member in FIG. 7A for closing the entrance;

FIG. 8 is a front perspective view of a modular sleeping structure of the invention with eight sleeping modules;

FIG. 9 is a front view showing an arrangement of four closure members for four sleeping modules of the modular sleeping structure in FIG. 8;

FIGS. 10A to 10D are graphical interfaces that allow user to interact with a computer device through graphical icons and visual indicators for booking, accessing and using a sleeping module in FIGS. 1A and 1B;

FIGS. 11A to 11F are graphical interfaces that allow user to interact with a computer device for providing information to a control system managing one or more sleeping modules in FIGS. 1A and 1B;

FIG. 12 is a QR code generated by the control system for the user to access the sleeping module in FIGS. 1A and 1B;

FIG. 13 is a graphical interface after checking in with the control system using the QR code in FIG. 12;

FIGS. 14A to 14C are graphical interface of a map made available to the computer device of the user after checking in;

FIG. 15 shows various interfaces of a chat room available to the computer device of the user after checking in;

FIG. 16 shows an interface of a chat room for communication with the control system of the sleeping module;

FIG. 17 shows graphical interfaces on the computer device for controlling devices provided within the sleeping module; and

FIGS. 18A and 18B shows graphical interfaces on the computer device for checking out of the sleeping module.

### DESCRIPTION OF THE INVENTION

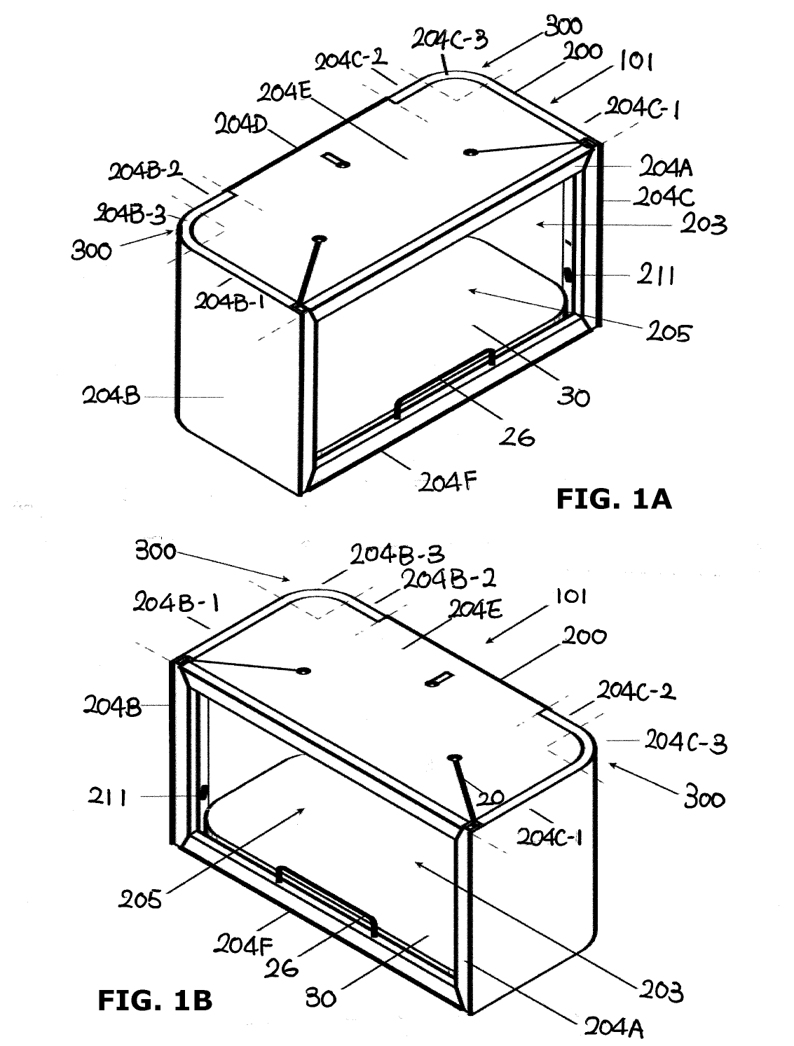

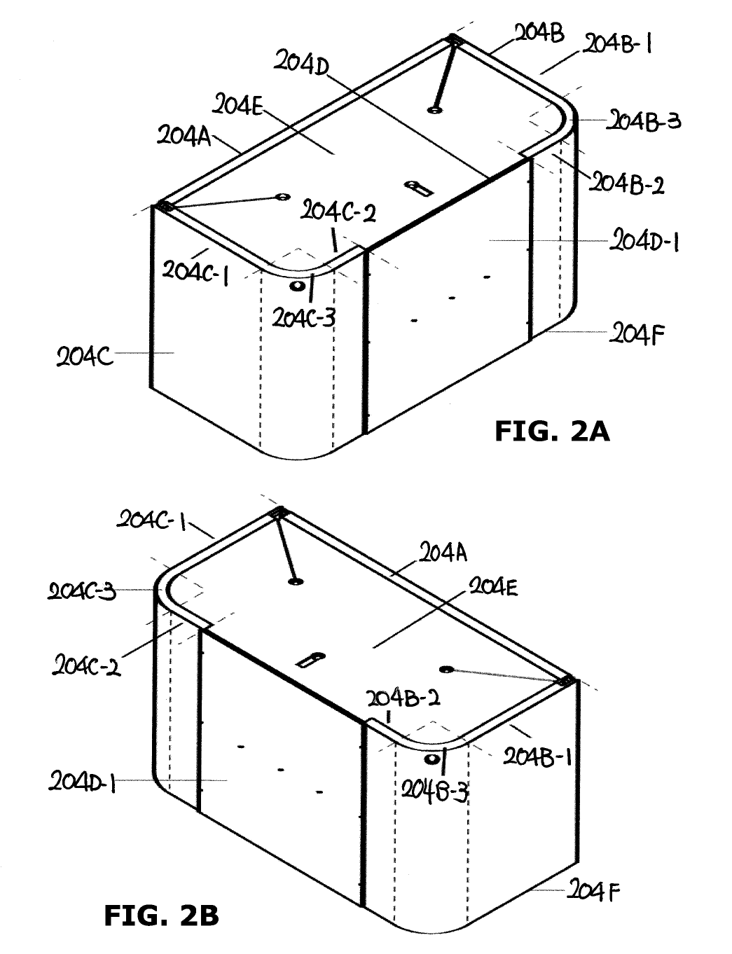

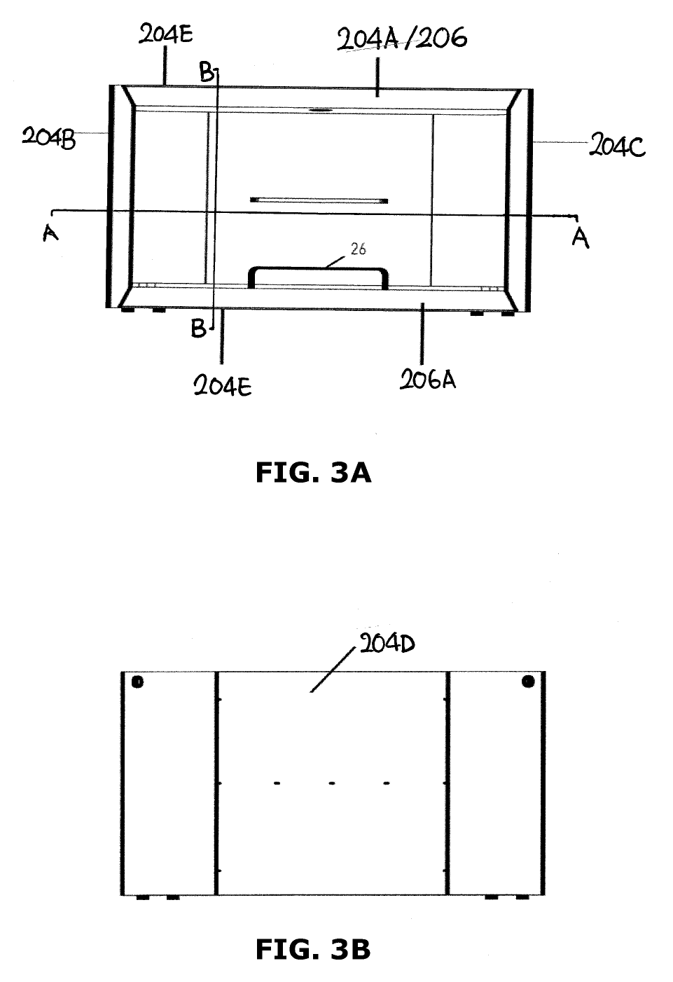

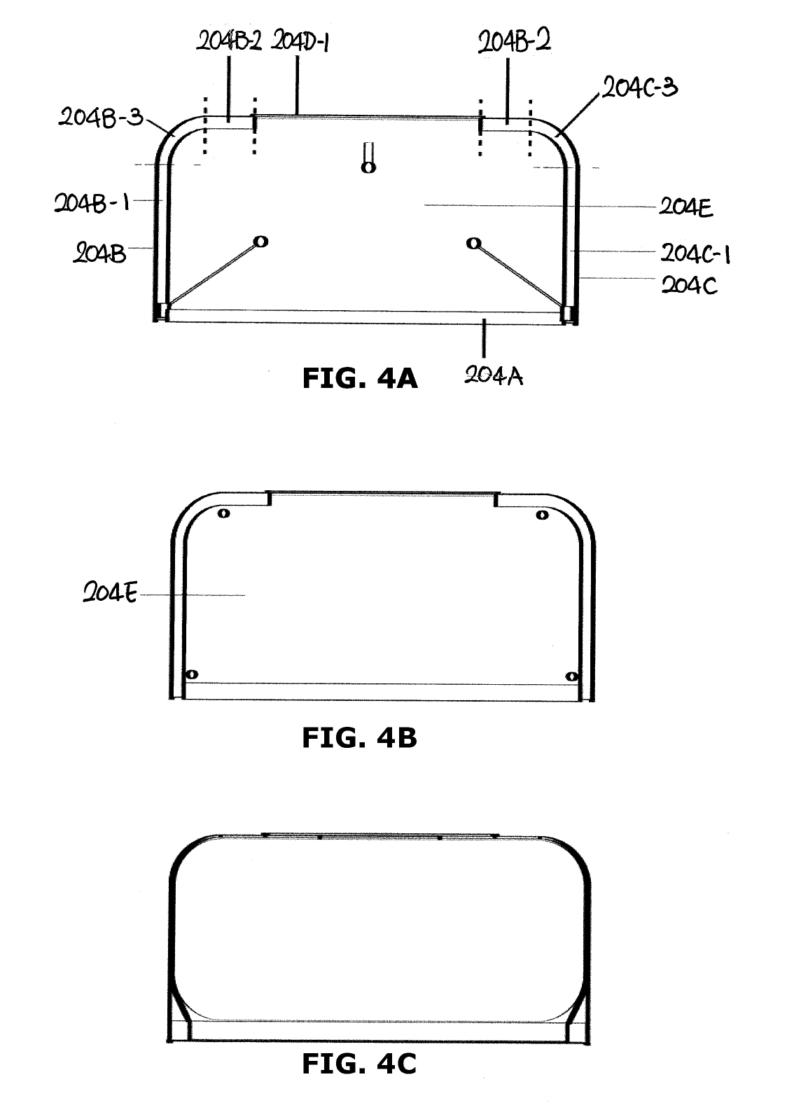

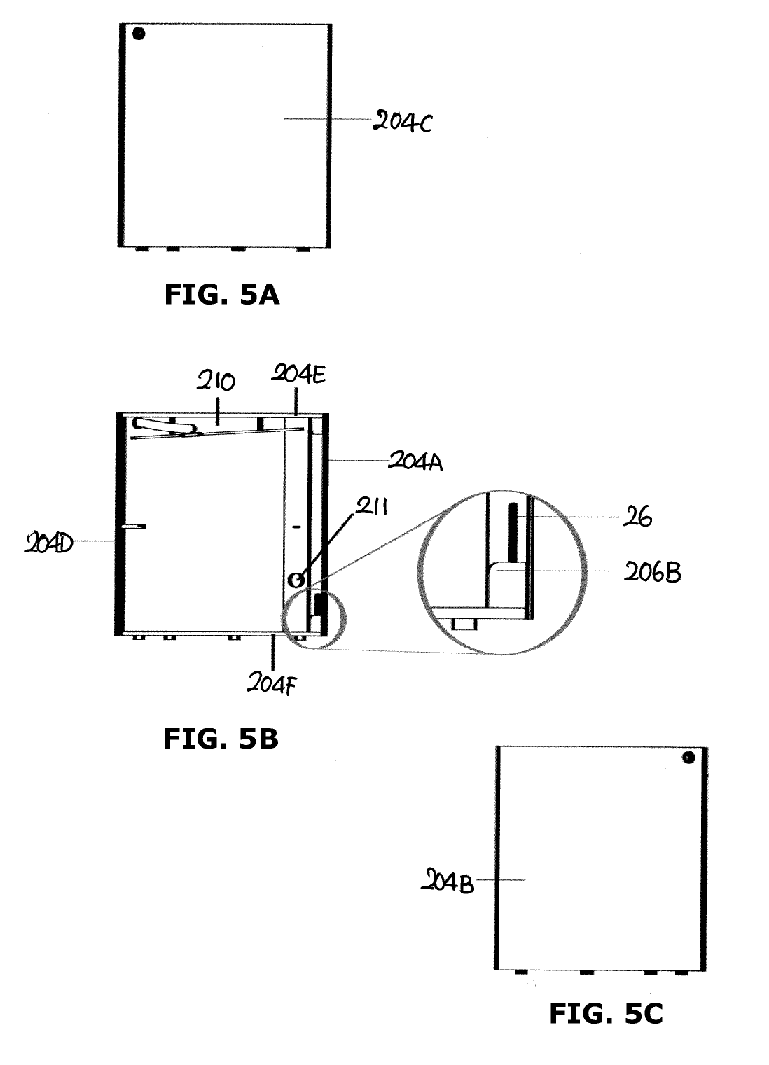

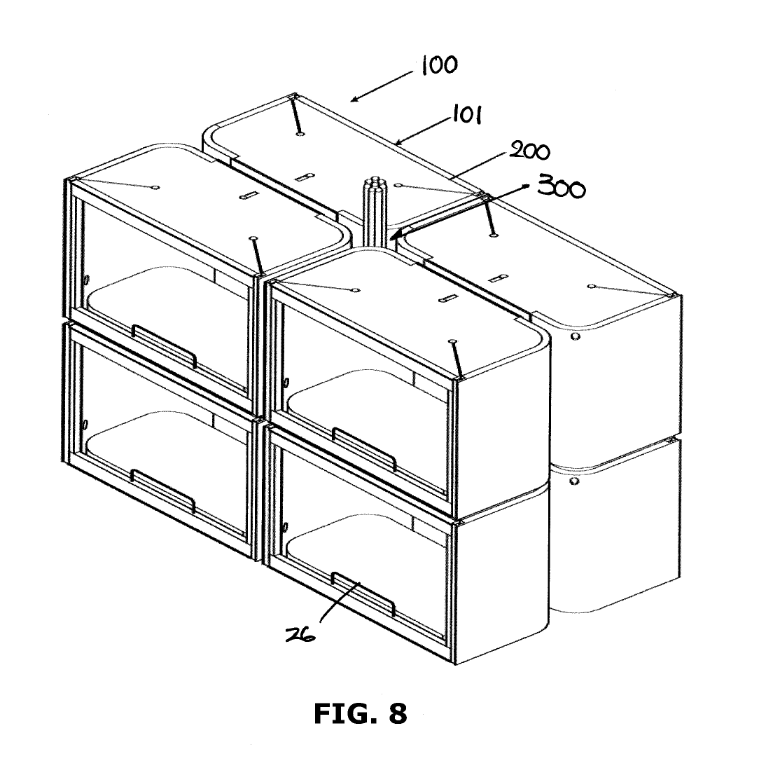

Referring to FIGS. 1A to 7B there is shown a sleeping module 101. In a preferred embodiment, eight of these sleeping modules 101 may be assembled to form a modular sleeping structure 100 as shown in FIGS. 8 and 9. The number of sleeping modules 101 in one modular sleeping structure 100 may vary upon needs.

In a preferred embodiment, the sleeping module 101 with a housing 201 that takes a generally rectangular shape with all four rear corners 202 being rounded and a front entrance 203 in the form of a rectangular aperture occupying almost the entire front wall 204A of the housing 200. In the specific embodiment, the housing 200 has six walls 204A to F defining a space 205 dimensioned to accommodate a user in at least a lie-flat position. This is only an example. The shape of the sleeping module 101 may vary e.g. in the form of a sphere with chamfered top and bottom.

The entrance 203 permits access to and from the housing 200. A gripping member/handle 26 may be provided near or at the lower end of the entrance 203 to assist the user e.g. when accessing the sleeping module 101.

The left and right side walls 204B and 204C each includes a turn that extends into the back of the sleeping module 101. The turn forms the rounded corners at the back of the sleeping module 101.

In more detail, the side walls 204B and 204C may be considered to have three portions, the first portion 204B-1 or 204C-1, the second portion 204B-2 or 204C-2 and the third portion 204B-3 or 204C-3. The first portion 204B-1 or 204C-1 comprises the side wall 204B or 204C of the housing 200. The second portion 204B-2 or 204C-2 form part of the rear wall 204D of the housing 200. The third portion 204B-3 or 204C-3 joins the first and second portion and is an arched wall.

The first and second portions 204B-1 or 204C-1 and 204B-2 or 204C-2 extend along first and second imaginary planes X and Y. These two planes intercept forming an imaginary intersection point A. The further wall portion 204C-3 is formed behind the intersection of the imaginary planes creating an auxiliary space 300 external of the housing 200 at the corner.

The housing 200 defines an auxiliary space 300 externally of the housing 200 and behind the intersection of two orthogonal imaginary border planes X and Y of the housing 200. As shown in FIG. 8, the auxiliary space 300 forms a channel through which electricity and water supplies run external to the housing 200 before entering the ceiling 204E.

The rear wall 204D of the housing 200 comprises the second portions 204B-2 and 204C-2 of the side walls 204B and 204C. It further includes a central panel 204D-1 which is thinner than the second portions 204B-3 or 204C-3.

The entrance 203 leads directly into the space 205 from the surroundings. A frame 206 surrounds and delimits the entrance 203. The frame 206 includes a beveled inner edge. A lower portion 206A of the frame 206 has a height that is substantially the same as that of a mattress 30 which covers a floor of the space 205. The top of the mattress 30 flushes with the upper edge of the lower portion 206A.

The walls 204A to F are preferably doubled-walls defining a hollow interior 210 therebetween and through which air, water and electricity supplies (hereinafter known as supplies) including cables and pipelines (air/fluid/exhaust) run. In the preferred embodiment, only a ceiling 204E of the housing 200 is double-walled. The uppermost panel 204E-1 of the ceiling 204E is relatively easily removable such that maintenance on the supplies can be done. Openings are provided on the uppermost panel 204E-1 for the supplies to enter the hollow portion 210. Grooves 20 are provided on the upper most panel 204E-1 through which cables that run inside the ceiling is lead to the front wall 204A.

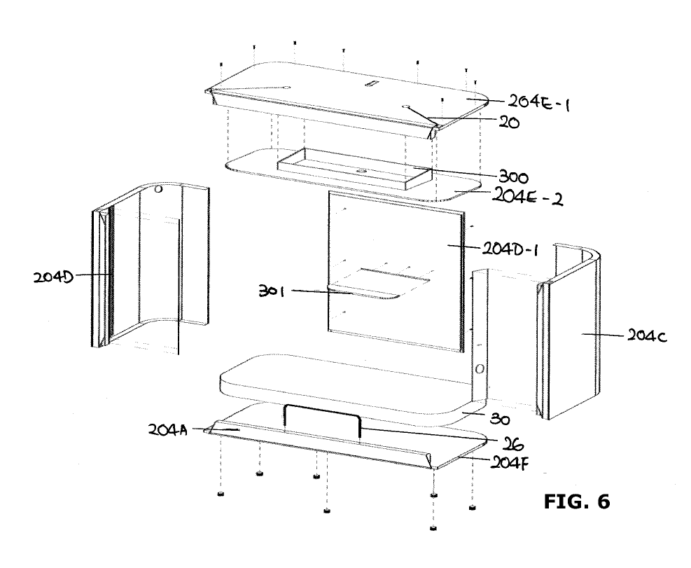

Referring to FIG. 6, the upper and lower panels 204E-1 and 204E-2 defines a box 300 in which electric wires and air conduits run. An opening on the lower panel 204E-2 permits access of the wire and conduits into the space 205.

A shelf 301 is assembled onto the central panel 204D-1 extended perpendicular therefrom. A socket cover is provided on the side wall 204C adjacent the frame 206.

The mattress 30 is in particular arranged to substantially cover an inner surface of the bottom wall 204F. The mattress 30 may comprise any suitable material commonly used for mattresses. The mattress 30 can have a water-washable, waterproof and/or skin tolerable casing such as of synthetic polymers like polyamides or polyvinylchloride. The bottom wall 204F includes an upturned wall at the front of the housing 200 onto which the handle 26 is attached. The upturned wall forms part of the front wall 204A.

The lower panel 204E-2 of the ceiling has openings through which the supplies enter the space 205. The rest of the walls may well be double-walled to create more hollow portions 210 for more advanced and complicated settings. For example, cables may run through the interior of the side walls 204B and 204C to the sockets. Furthermore, the double wall should enhance the soundproofing and fire resisting abilities of the housing 200. In the preferred embodiment, the size and height of the hollow portion 210 may be adjusted according to needs.

The lower panel 204E-2 may be a hanging ceiling. The relative position of the hanging ceiling 204E-2 in the housing 200 may be adjustable according to needs.

The walls 204A to 204F are preferably sheet material comprise of or essentially consist of at least one of plastic, wood or a wood product such as medium density fiberboard, glass fiber reinforced plastic and/or a high strengths foam. Selection of a preferred material depends on the environmental condition where the sleeping module 101 is to be placed. Rigidity is a main concern.

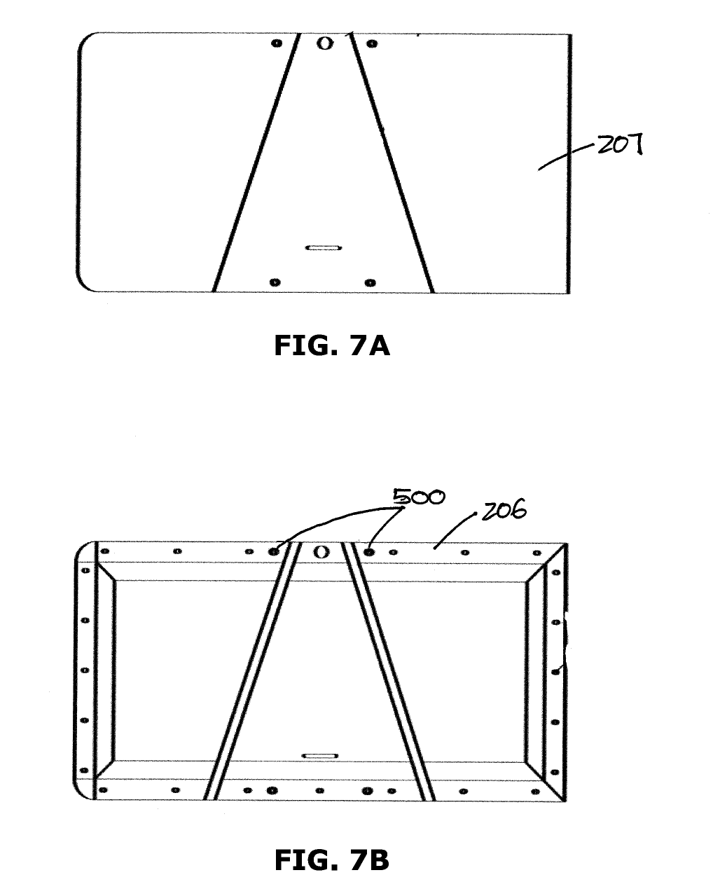

The frame 206 is vertically standing in the form of a flat rectangle extending longitudinally, which consists of two vertical posts connected at extreme ends by two horizontal beams as can be seen in FIG. 7B. The frame 206 comprises ferromagnetic or it has a number of discrete magnets arranged thereon. This is to magnetically attract a closure member 207 which is dimensioned to close off the entrance 203. The closure member 207 may include magnets arranged around its periphery.

In the front wall 204A, the aperture 205 is surrounded by the frame 206. The frame 206 is co-operable with the openable closure member 207 which at least partially obstructs the aperture 205 to provide some privacy to the user in the space 203. The closure member 207 may be foldable and can be readily stowed away. The closure member 207 is held in the closed position by way of magnetic force. Magnet or ferramagnets may be detachably arranged on the closure member 207 and/or on the frame 206. The magnetic fastener may further comprise one or more of guarding means or co-operative catching means adapted to resist relative lateral movements between the cover member and the frame 206.

Reinforced eyelets 500 are provided to allow for a strong attachment by screw or hook such that, when utilized, the cover could not be completely detached from the frame. The reinforcement will ensure that the attachment is durable against forceful usage.

In the preferred embodiment, the closure member 207 is air permeable and that is achieved by way of small holes opened on the closure member 207. The closure member 207 may be a two layered structure enclosing the magnets or ferromagnets to couple with the corresponding ferromagnets or magnets on the frame 206. The closure member 207 includes a base layer 207A and a covering layer 207B which is preferably a fabric layer, in particular the fabric layer is a felt layer or a layer comprising felt. The dimensions of the closure member 207 exceed in dimensions of the access aperture by more than 5%, more preferably by more than 10% in order to further ensure a complete coverage of the access aperture.

Outside the housing and supported on the front wall 204A there is a transportation structure in the form of a ladder/staircase 208 for user to access the sleeping module above ground level. The ladder 208 is integrally formed with a mount that attaches or is integrally formed with the front wall 204A by way of welding. In another embodiment, this may well be an electrical elevator plate 208 to transport the user from one, lower sleeping module 101 to another, upper sleeping module 101.

In the space 203, the inner surface of the walls 204A to F may be padded by cushioning or soft materials and preferably be voided of any edges and corners for protection of the user. In an embodiment, the sleeping module further comprises:
opening for supply and/or dissipation of at least one of water, electricity, oxygen or air;
means for lightening, ventilation, air flow, oxygen flow and/or electricity flow; and
means for controlling the lightening, ventilation, air flow, oxygen flow and/or electricity flow.
at least one charging socket; and
at least one mean for storage.

The sleeping module 101 may include:
means for water supply and a washing facility;
a display screen for television and/or radio;
an internet access;
a smart phone controller;
an emergency bottom and/or a loudspeaker; and/or
a sleep quality sensor.

The sleeping module 101 is a self-contained accommodation used independently or as one of the many sleeping modules 100 in the modular sleeping structure 100. As shown in FIG. 8, eight sleeping modules 101 form two levels of modular sleeping structure 100. The first level has four sleeping modules 101. Two of them are placed side-by-side forming a pair. Another two are again placed side-by-side forming another pair. The two pairs are arranged back-to-back forming the first level. The same arrangement forms a second level on top of the first. In other words, the second level is preferably directly stacked on top of the first level. A ladder 208 is provided for the user to reach the second level of sleeping modules 101. One ladder 208 is shared amongst four sleeping modules 101. The ladder 208 is placed on the front wall 204A at the junction between adjacent sleeping modules 101.

Preferably, an upper portion of the ladder 208A is a handle 26 and the lower portion 208B includes varies steps horizontally spaced and evenly distributed along a shaft.

The sleeping modules 101 may be affixed to one another by way of a mechanical connector e.g. clamps. In an alternative embodiment, the sleeping modules 101 may be affixed to one another in a modular sleeping structure 100 by way of super magnets or adhesive.

The modular sleeping structure 100 and sleeping module 101 of the present invention are advantageously efficient with regard to installation space while providing an improved comfort for the accommodated subjects. Due to the efficient design in terms of installation space it is, thus, possible to offer at a comparatively low price a place for sleeping and rest.

The auxiliary space 300 defines a channel through which external pipelines (air or fluid including exhausts) and electric wires run to support an individual sleeping module 101. The auxiliary spaces 300 of four sleeping modules 101 in one level collectively defines a common channel, preferably at the center and common to all four sleeping modules in that level, through which external pipelines (air or fluid including exhausts) and electric wires (hereinafter known as supplies) run and eventually branch out to support respective sleeping module 101. When two levels of four sleeping modules 101 are stacked one above the other, the auxiliary space 300 defined in each level of four sleeping modules 101 are aligned to form a lengthened channel through which external pipelines and electric wires run to support the individual sleeping modules 101 in both levels. The supplies enter the sleeping module 101 through the hollow portion 210 in the top wall 204E.

Further, the sleeping module 101 has an aesthetic appearance as well as a simple construction and the modular sleeping structure 100 allows an easy repositioning according to the individual accommodation needs while ensuring a simple and rapid building up of such modular sleeping structure 100.

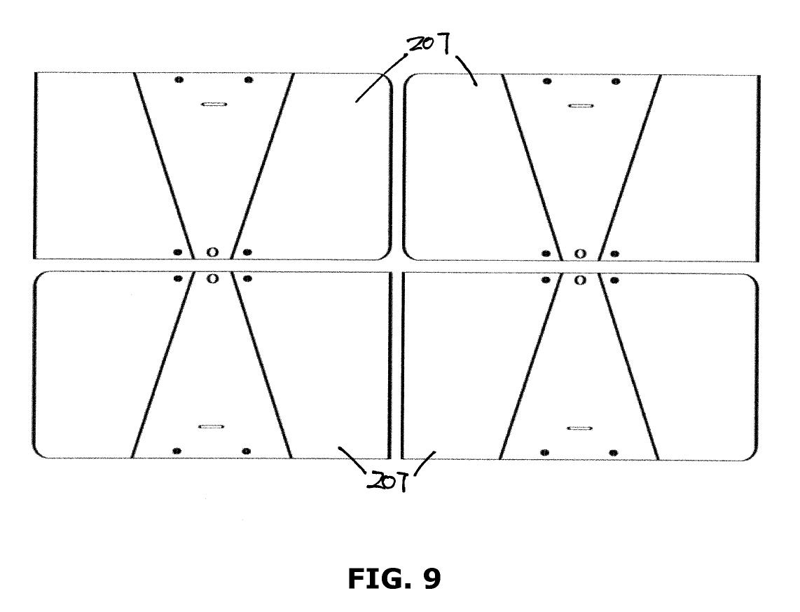

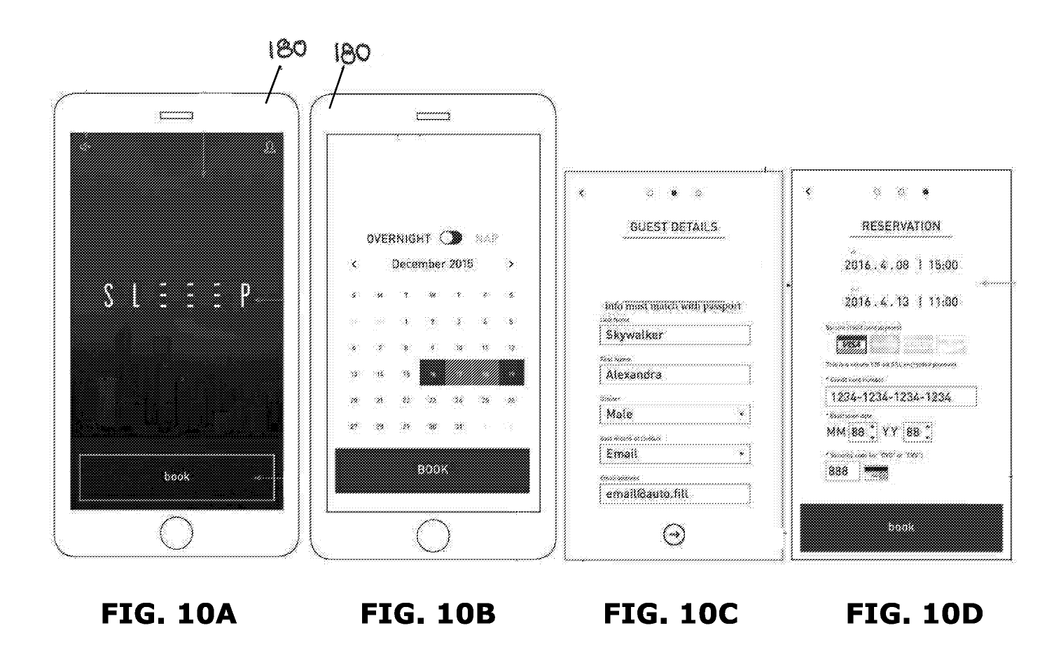

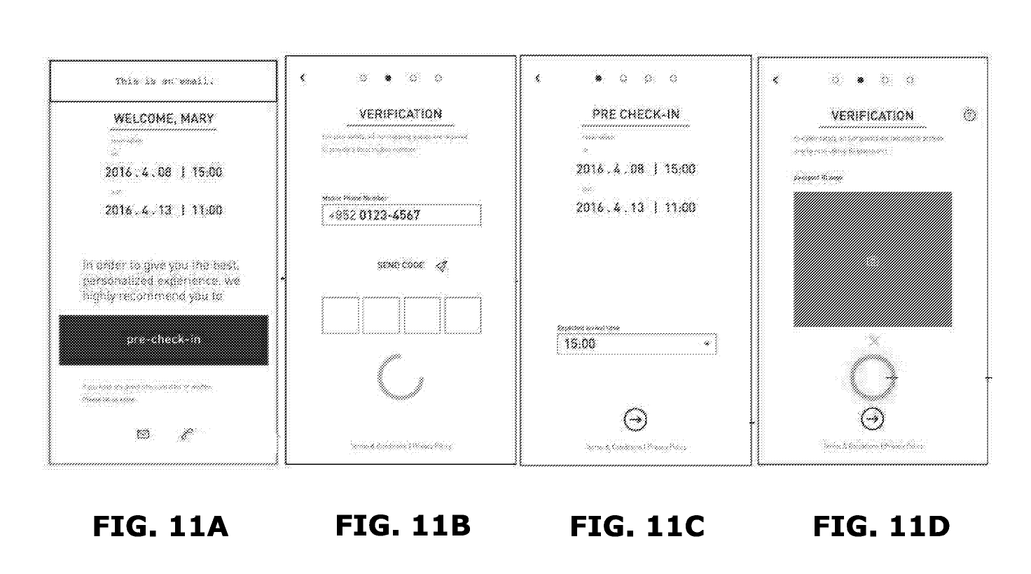

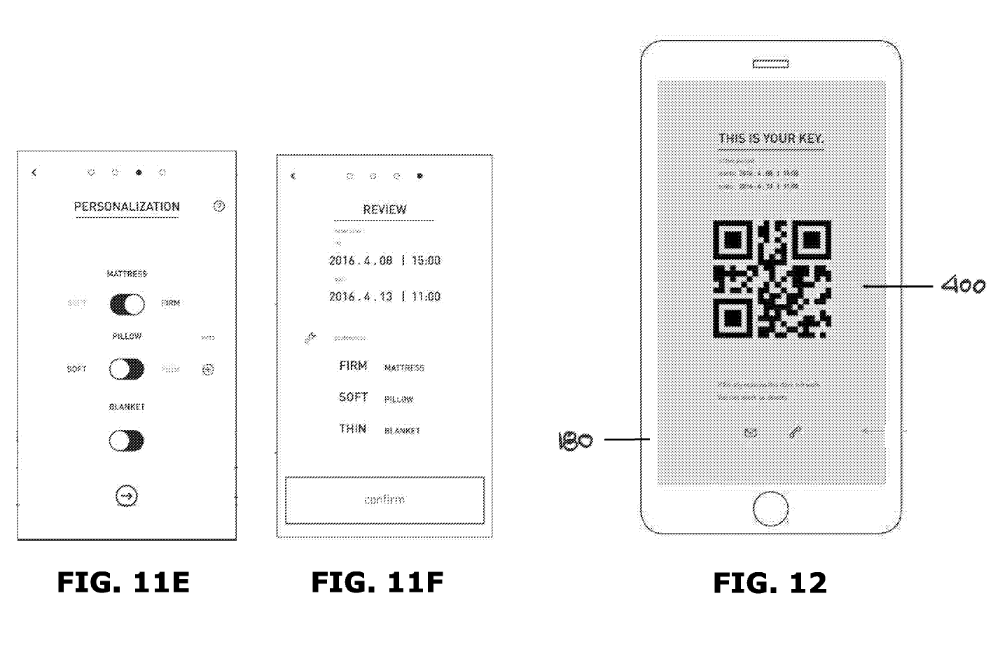

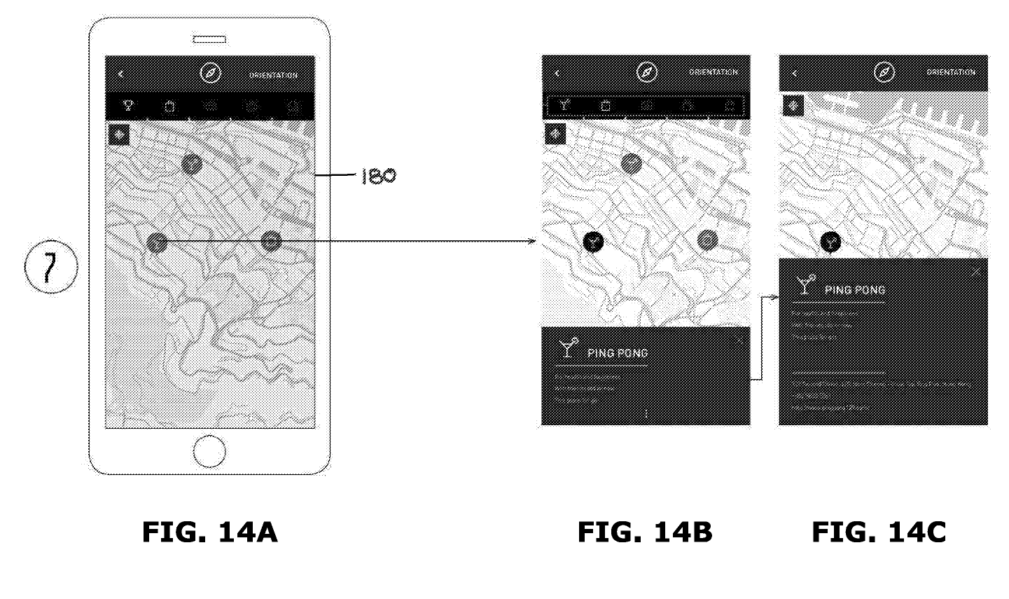

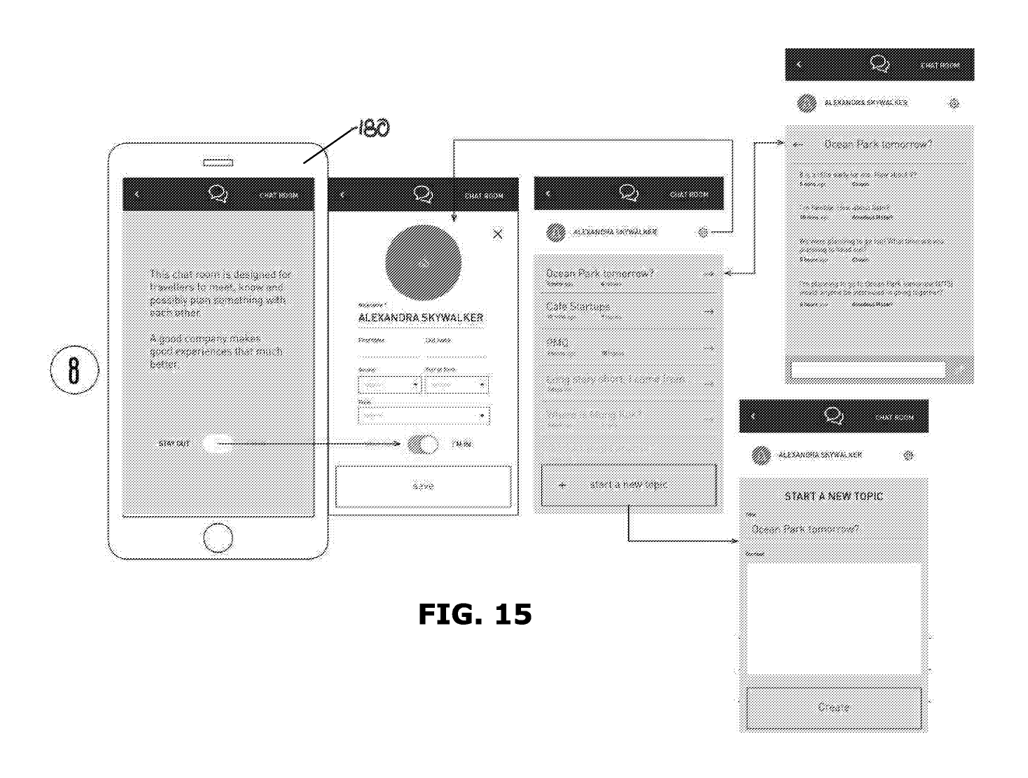

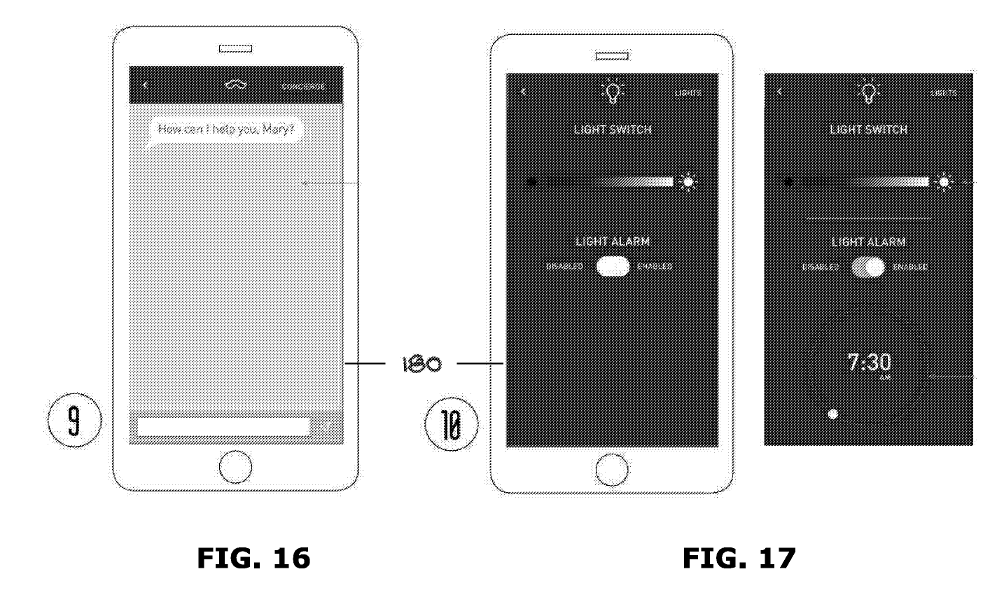

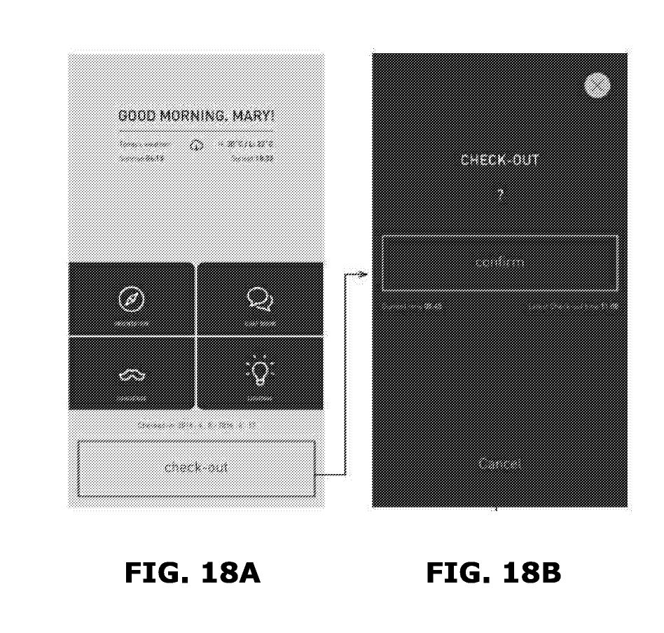

Referring to FIGS. 10A to 18B, a system with access control means may be applied to restrict the access into or out of the sleeping module 101. For example, to protect against personal items left in the sleeping module 101 or to prevent child from exiting without proper supervision.

The system includes at least one sleeping module 101, a control system and an external computer device 180.

The control system prevents access of the sleeping module 101 without authorization. Authorization is given to a registered user registering through a self-contained program or a piece of software downloaded to the external computer device.

To register, a user may open the program or software with the external computer device. A user may make a booking with the control system for using the sleeping module 101 at a specified time. By clicking a “book” button, the program or software leads the user to a calendar where dates of using the sleeping module 101 can be entered. Once the dates are set, the user may click the “book” button to input personal details for verification purpose at a later stage. Online payment may be made through the program. A set of basic information based on the input personal details is created for generating a code that allows the control system to identify the user when the code is presented.

Pre-registration is possible through the external computer device. A verification code is sent to the user through electronic means. The verification code has to be entered into the control system during pre-registration for continuation and completion of the pre-registration. The user may enter the expected time of arrive at the sleep module 101.

A capture of the image of the user identification document may be required and such image is stored with the control system linked to the basic information of the user made available in the code. At pre-registration, the user may indicate his/her required settings in the sleeping module 101, including but not exclusively of, the hardness of the mattress 30, the pillow softness, and the need of blanket and lighting, etc. The required settings will be stored at the control system linked to the basic information of the user. A further code 400 is generate by the system and sent to the user through electronic means. The code contains the basic information of the user. The code generated from the basic information of the user is readable by a scanner of the control system. By scanning the code, the control system retrieves the basic information of the user and all the other information stored within the control system and linked to such basic information.

The code is presented to the scanner when checking-in the sleeping module 101. The control system automatically retrieves all stored information linked to the code. With the preference settings, the sleeping module 101 may be prepared accordingly. In the preferred embodiment, upon checking-in, the preference settings may be executed manually by a worker directly accessing the sleeping module 101 and preparing it accordingly, or the electronic devices in the sleeping module 101 may be controlled by a control panel remote from the sleeping module 101 and any such preference settings may be executed remotely. Alternatively, by presenting the code to the scanner, the control system may automatically generates one or more signals to the control panel for executing the preference settings in the sleeping module 101. The code is preferably a QR code and may function as a key.

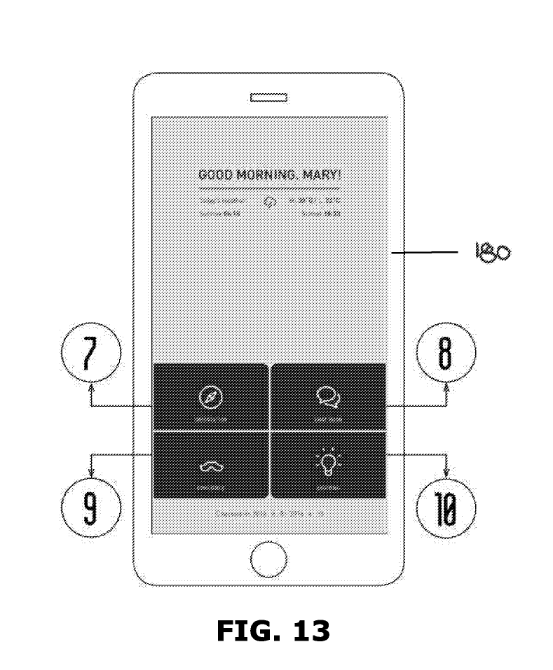

A number of functions as shown in the graphic user interfaces in FIGS. 13 to 18B become available after checking-in. A chat room made possible direct chatting with an assigned person for serving the user through the control system. Another chat room may be made available for users of different sleeping module 101 to chat and exchange information. The software or program may change the external computer device into a remote control for controlling the electric devices in a specific sleeping module to which the user checked in.

The various aspects of the invention has been given by way of example only, and various other modifications of and/or alterations to the described embodiments may be made by persons skilled in the art without departing from the scope of the invention as specified in the appended claims.

1. A sleeping module comprising:
a housing defining a space dimensioned to accommodate a user in at least a lie-flat position,
an entrance to permit access to and exit from the space of the housing, an openable closure member provided with the housing to at least partially obstruct the entrance for isolating the space from the surroundings,
characterized in that a holder useful with the openable closure member is provided at the housing to releasably hold the openable closure member in a closed position by way of an attractive force.

2. The sleeping module as claimed in claim 1, wherein the openable closure member is held in the closed position by way of magnetic force.

3. The sleeping module as claimed in claim 1, wherein the entrance comprises an opening on a wall of the housing delimited by an edge portion.

4. The sleeping module as claimed in claim 3, wherein the edge portion is equipped with a magnet.

5. The sleeping module as claimed in claim 3, wherein the openable closure member is equipped with a magnet for magnetically engaging the edge portion of the entrance.

6. The sleeping module as claimed in claim 5, wherein the openable closure member comprises a foldable closure member.

7. The sleeping module as claimed in claim 6, wherein the openable closure member is air permeable.

8. The sleeping module as claimed in claim 3, wherein the wall of the housing includes a hollow portion for passage of electricity and water supply to the space.

9. The sleeping module as claimed in claim 8, wherein the wall of the housing comprises a double wall with the hollow portion formed therebetween.

10. The sleeping module as claimed in claim 9, wherein the hollow portion is located at a top portion of the housing.

11. The sleeping module as claimed in claim 10, wherein the housing defines an auxiliary space externally of the housing and in a corner at intersection of two orthogonal imaginary border planes of the housing.

12. The sleeping module as claimed in claim 10, wherein the wall of the housing includes two wall portions extending along first and second imaginary planes, the first and second imaginary planes intersect forming an imaginary intersection point, the two wall portions are connected by a further wall portion that extends behind the intersection of the first and second imaginary planes creating an auxiliary space external of the housing.

13. A modular sleeping structure comprising an assembly of at least two of the sleeping modules as claimed in claim 12, wherein the sleeping modules are arranged side-by-side to define a common channel for collective supply to pass which then branch off to supply the respective sleeping module.

14. The modular sleeping structure as claimed in claim 13, wherein, the collective supply includes at least one of a mechanical, electrical and plumbing system.

15. (canceled)

16. The modular sleeping structure as claimed in claim 13, wherein the common channel is at least partially defined by the further wall portion of at least one sleeping module.

17. The modular sleeping structure as claimed in claim 14, wherein the sleeping modules are accessible to and from by the provision of a transportation structure supported by at least one of the sleeping modules.

18. The modular sleeping structure as claimed in claim 17, wherein the transportation structure comprises a ladder being mounted to the sleeping module by a support frame.

19. The modular sleeping structure as claimed in claim 18, wherein the ladder includes a plurality of steps connected by a shaft which has an upper portion forming a handle.

20. The modular sleeping structure as claimed in claim 19, wherein the sleeping modules are affixed to each other.

21. The modular sleeping structure as claimed in claim 13, wherein the sleeping modules are affixed to each other by way of mechanical coupling.

22. The modular sleeping structure as claimed in claim 20, wherein the sleeping modules are affixed to resist lateral movement by way of mutual support.

23. The sleeping module as claimed in claim 22, wherein the housing comprises an exterior covered by a layer of material for structural or visual enhancement.

24. The sleeping module as claimed in claim 23 further comprising a control module for controlling device installed in the sleeping module, the control module is guarded by a security system.

25. A method of accessing the sleeping module as claimed in claim 1 by the user including the steps of:
providing identification information of the user to a control system;
providing information of an intended period of use to a security system;
receiving a key generated by the control system, the key permits access to the sleeping module and control of the device; and
presenting the key to the control system thereby gaining access to the sleeping module.

26. The method as claimed in claim 25, wherein the key stores information provided by the user, by presenting the key to the control system, stored information become accessible by the control system.

27. The method as claimed in claim 26 further comprising the step of indicating preference settings on device provided with the sleeping module.

28. The method as claimed in claim 27, wherein the preference settings are stored with the key or the control system.

29. The method as claimed in claim 28, wherein the key comprises a QR code.
